(19) United States
(12) Patent Application Publication
(10) Pub. No.: US 2013/0292226 A1
(43) Pub. Date: Nov. 7, 2013

(54) METHOD AND SYSTEM FOR STRIPPING AND BLANKING A CARDBOARD

(71) Applicants: David Ben-David, Rehovot City (IL); Yaki Stern, Shoam (IL)

(72) Inventors: David Ben-David, Rehovot City (IL); Yaki Stern, Shoam (IL)

(73) Assignee: HIGHCON SYSTEMS LTD, Yavne (IL)

(21) Appl. No.: 13/875,894

(22) Filed: May 2, 2013

Related U.S. Application Data
(60) Provisional application No. 61/641,534, filed on May 2, 2012.

(51) Int. Cl. B65G 15/58

(52) U.S. Cl. CPC B65G 15/58
USPC 198/345.1; 198/688.1

(57) ABSTRACT

A pretreated-cardboard stripper that obtains a cardboard item and strips or blanks the cardboard item using laser cutting, die cutting or other techniques. The cardboard item may be a single item or multiple sections that are jointed together. After stripping or blanking, the stripper operates to sort the sections and joints from the waste by a vacuum sorter. The vacuum sorter includes a vacuum chamber with openings along its surface or certain areas of the surface and a peeler. After stripping, the pre-treated cardboard is transferred by the peeler along the surface of the vacuum chamber. The waste of the cardboard (areas between the sections and joints) may be coupled to the vacuum chamber surface while the pre-treated cardboard is being transferred by the peeler along the surface of the vacuum chamber, which has the advantage of operating to disconnect and thus sort the waste from the sections.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on May 2, 2012 and assigned Ser. No. U.S. 61/641,534 which application is incorporated herein by reference in its entirety. This application is related to the following United States pending applications, which are hereby incorporated by reference: Ser. No. 13/108,389 having a filing date of May 15, 2011 and Ser. No. 13/684,196 having a filing date of Nov. 22, 2012, and the International Application bearing the title of “Cardboard-handling system and method” assigned Ser. No. PCT/IL2012/000377.

### TECHNICAL FIELD

The present disclosure generally relates to the die-cutting and die-creasing industry, and more particularly the disclosure relates to a system and method of stripping and/or blanking a pre-treated cardboard.

### BACKGROUND ART

The rapid evolution of trade around the world (globalization) has created a significant demand for packaging in order to transfer/distribute goods to different remote areas. The transport of goods may be done by: ship, airplanes, trucks, and so on. The transport of goods may be performed by: the manufacturer; different suppliers; individual persons; etc. Further, a significant demand for different brochures, flyers, etc. also takes part in trade. The different brochures/flyers may have pre-folds and/or embossing, for example. Embossing such as, but not limited to Braille writing.

Packaging has taken on a major role in the marketing of products in today's environments. The package in which the goods are packed and presented, in a store for example, may determine if the goods will be appealing to a potential buyer in the store or not. Thus, the packaging appearance can have a direct effect on the sales of merchandise. The brochures, flyers, and so on may also contribute to the sales/awareness with regards to a product/service etc.

Henceforth, throughout the description, drawings and claims of the present disclosure, the terms package, paperboard box, parcel, box, carton box, cardboard box, brochure, flyers, etc. may be used interchangeably. The present disclosure may use the term package as a representative term for the above group.

In the process of constructing a package, it is well known in the art that as a preliminary requirement, a pre-treated cardboard and/or paper based material should be purchased or prepared. The paper-based material may be constructed in a variety of forms and using a variety of different types of materials as well as combinations of material types. For example, the material types may include, but are not limited to: waxed paper, cartridge paper, art paper, etc. Henceforth, throughout the description, drawings and claims of the present disclosure, the terms cardboard, card-stock, display board, corrugated fiberboard, paperboards of different paper based material, folding boxboard, carton, blanks, laminated paper, plastics sheets, and so on, may be used interchangeably and, the various embodiments as well as anticipated variants thereof may operate on any of these materials as well as combinations of these materials and other materials. Thus, while the present disclosure or certain embodiments may be presented as working with cardboard, this is just a representative term for the above group as well as variants thereof.

The pre-treatment of a cardboard may include one or more of the following actions: creating folding lines along the cardboard to ease and provide accurate folding of the cardboard; piercing the cardboard in different areas; creating embossment in different areas of the cardboard; cutting the raw cardboard into predefined profiles; cutting openings, slits or slots in the cardboard; as well as other actions and combinations of two or more of these actions. Henceforth, throughout the description, drawings and claims of the present disclosure the terms pre-folded cardboard, and pre-treated cardboard may be used interchangeably. The present disclosure may use the term pre-treated cardboard as a representative term for the above group of actions as well as combinations of these and other actions.

Some common techniques for preparing a pre-treated cardboard include the acts of placing the cardboard between dies. A few non-limiting examples of the types of dies include: a cutting-die; a creasing-die; an embossing-die; a scoring-die; a counter die; a combination of the different types of dies; as well as other die types and combinations of two or more of these different types of dies. Other examples of common techniques for preparing a pre-treated cardboard may include using one or more lasers. Other exemplary common techniques comprise a combination of them, and so on.

### SUMMARY OF THE DISCLOSURE

Among other things, the present disclosure provides a novel pretreated-cardboard stripper system, apparatus and method that may: strip a plurality of sections (package layout, for instance) from a pretreated cardboard; blank a pretreated cardboard; separate between the one or more sections themselves as well; sort between the stripped sections and the waste; a combination of two or more of the above as well as variants thereof. Henceforth throughout the description drawings and claims of the present disclosure the terms ‘strip’ and the term ‘blank’ may be used interchangeably. The term ‘strip’ may be used as the representative term of the above group

In some embodiments the pretreated-cardboard stripper system, apparatus and method may be implemented as part of a pre-treating cardboard systems, for instance. Pre-treating cardboard systems such as but not limited to: common steel-rule die industry, surface-adhesive-rule technology (SART), laser industry, a combination of them and so no. In other embodiments the pretreated-cardboard stripper may be a standalone system.

More information on the surface-adhesive-rule technology (SART) may be found in related United States non-provisional application bearing the title of “Method and system for surface adhesive rule technology” having Ser. No. 13/108,389 and which is incorporated above by reference in the Cross-reference to related applications section.

In some embodiments, a pretreated-cardboard stripper may obtain a pre-treated cardboard strip and/or blank, or a plurality of sections connected by joint. The stripping and/or blanking may be done by different techniques. Non-limiting examples of such techniques may include: laser cutting, die cutting, etc. The pretreated-cardboard stripper may sort the sections and joints from the waste by a vacuum sorter.

Some embodiments of a vacuum sorter may include a vacuum chamber with openings along its surface or portions or certain areas of the surface) and a peeler. The pre-treated cardboard after may be transferred by the peeler along part of the surface of the vacuum chamber.

The peeler may hold (by grippers, for example) the pre-treated cardboard by one or more of the pre-treated cardboard's sections and/or joints and/or boarder. The waste of the cardboard (areas between the sections and joints) may be coupled to the vacuum chamber surface while the pre-treated cardboard is being transferred by the peeler along the surface of the vacuum chamber. Advantageously, disconnecting and thus sorting the waste from the sections.

The waste may then be removed from the surface of the chamber utilizing different techniques. Non-limiting examples of such techniques may include: brushing off the waste (while the vacuum is turned off or left working); the vacuum chamber may be a drum or a belt mechanism that may pivot around an axis thus stopping the vacuum and pivoting the drum or belt to where the waste is on the underside of the drum or belt, then the gravitational force will be applied and the waste may fall.

In another embodiment, the peeler grabs the waste and peels away from the vacuum surface, thus sorting and leaving the sections on the vacuum chamber surface. The sections may then be removed by techniques similar to the above-described techniques for removing the waste.

The pretreated-cardboard stripper may further include a controller, the controller may be configured to synchronize the operation between the peeler and the pretreated cardboard sections/boarders/waste along the vacuum chamber surface; between the motion of the peeler and the motion of the conveyor; and so on. Synchronization may utilize information gotten from sensors, from encoders, etc.

Another embodiment of a pretreated-cardboard stripper may include a cutting mechanism that cuts (by laser, for instance) along the borders of the sections, joint and/or border of a pre-treated cardboard while the pre-treated cardboard lays on a surface of a vacuum chamber. After the process of cutting the surrounding of the sections and joints has been completed, a peeler may obtain the pre-treated cardboard by securing one of one or more of the pre-treated cardboard's sections and/or joints and/or borders and transferring the pre-treated cardboard away from the surface of the vacuum chamber. Advantageously, the procedure results in disconnecting the sections from the waste and thus sorting the waste from the sections. The waste attached to the vacuum surface may be removed in similar ways described above.

In other embodiments, the sections may be cut all around their border, meaning no joints exist between the sections. The peeler may hold the pre-treated border area of the cardboards surrounding the sections, and then transfer the border material away from the vacuum chamber, thus leaving only the sections on the surface of the vacuum chamber. Advantageously, this feature results in sorting the waste from the sections.

The sections may then be removed from the surface of the vacuum chamber. The removal of the sections may be accomplished utilizing any of a variety of techniques such as, but not limited to: brushing of the sections (while the vacuum is turned off or left working); the vacuum chamber may be a drum or a belt mechanism that may pivot around an axis thus stopping the vacuum and pivoting may utilize gravitation and sections may fall into a collector; and so on

Yet in another embodiment of a pretreated-cardboard system, the stripper may include a selective mask sorter. A selective mask sorter may include a selective mask that may be constructed from plastic, cardboard, paper, etc., and a vacuum chamber with openings along its surface. The selective mask may be configured to have openings in substantially similar size and placement to the sections and the joints on a pre-treated cardboard, for example. Dies, and/or laser, etc., may create the openings of the selective mask.

The selective mask may be associated with, or coupled to, and thus exist along the surface of the vacuum chamber. The association or coupling may be implemented by grippers or vacuum as non-limiting examples. The vacuum chamber may be a drum or a belt pivoting around one or more axis, for instance.

The pretreated-cardboard stripper may further include a controller. The controller may be configured to and operate to synchronize an arrival of a pre-treated cardboard, after it has been cut around the sections and joints, to the surface of the vacuum chamber with the selective mask on top of it.

The controller may synchronize such that the pre-treated cardboard may be placed on top of the selective mask in a way that the sections and joints are placed substantially on the areas of the openings the selective mask. Synchronization may utilize information obtained from one or more sensors, from encoders, etc.

Advantageously when the vacuum chamber pivots, gravitational forces may cause the waste to fall from the belt or drum and into a waste-collector, while the sections and joints remain attached to the vacuum chamber surface.

The sections and their joints may be removed from the vacuum chamber utilizing a variety of different techniques. As non-limiting examples, the sections and their joints may be peeled from the vacuum chamber by utilizing a gripper, stopping the vacuum, a clamp, etc. The peeler may hold an area (i.e., one of the joints, sections, border, etc.) that is not attached by vacuum (an area left un-cut in the selective mask), for example.

In other embodiments, the selective mask may be a negative to the sections and their joints. Thus, the sections and their joints may fall from the vacuum chamber (by gravitation, for example) to a collector and the waste may stay on the surface of the vacuum chamber, and so on.

In some of the embodiments, the process of cutting around the surrounding of the sections and joints may be performed while the cardboard is on the vacuum chamber, via laser for example

In yet another embodiment of pretreated-cardboard system, the stripper may include an electrostatic selective mechanism. The electrostatic selective mechanism may include a drum or belt pivoting around one or more axis. The surface of the drum or belt may be coated with a coating that holds an electrostatic charge when in the dark, and conduct away such a charge when under light (amorphous selenium, ceramic or organic photo-conductors, for instance).

The coated surface may be charged utilizing a high voltage (a few thousand volts, for instance). A light source may then be used to discharge certain areas along the surface. For instance, a laser could be utilized as a light for discharging the certain areas. The areas discharge may be an image of the sections and joints of the pre-treated cardboard, or simply just the sections. The pre-treated cardboard may be charged as well.

Next a controller may synchronize an arrival of a pre-treated cardboard, after it has been cut around the sections and joints, to the surface of the electrostatic selective mechanism.

The synchronization may be such that the edge of the charged pre-treated cardboard may be attached to the coated surface of the drums/belt in an area charged, in a way that pulls the pre-treated cardboard toward and along the surface of the drum/belt.

The controller may synchronize the system such that the pre-treated cardboard may be placed on top of the drum/belt in a way that the sections and joints are placed substantially on the areas charged. The synchronization process may utilize information received from one or more sensors, from encoders, etc.

Advantageously when the drum/belt pivots, then gravitational forces may cause the waste to fall from the underside of the drum/belt and into a waste-collector while the sections and joints stay attached to the surface of the drum/belt.

The sections and their joints may be removed from the surface utilizing a variety of different techniques. Non-limiting examples of such techniques include peeling from the surface using a gripper, a clamp, stopping the vacuum; etc. The peeler may hold an area (one of the joints, sections, border, etc.) that is not charged (an area left charged on the surface), for example.

In other embodiments, the areas discharge on the surface of the drum/belt may be a negative of the sections and joints of the pretreated cardboard, or of just the sections. Thus the sections and their joints may fall from the drum/belt's surface (by gravitation, for example) to a collector and the waste may stay on the surface of the vacuum chamber, and so on.

This and other embodiments, features and aspects of the adjustable-stacker are described further in conjunction with the figures and the detailed description following.

Unless otherwise defined, all technical and/or scientific terms used herein have the same meaning as commonly understood by one of ordinary skill in the art to which the disclosure pertains. In case there is a conflict in the definition or meaning of a term, it is intended that the definitions presented within this specification are to be controlling. In addition, the materials, methods, and examples that are presented throughout the description are illustrative only and are not necessarily intended to be limiting.

Reference in the specification to “one embodiment” or to “an embodiment” means that a particular feature, structure, or characteristic described in connection with the embodiment is included in at least one embodiment of the disclosure, and multiple references to “one embodiment” or “an embodiment” should not be understood as necessarily referring to the same embodiment or all embodiments.

Implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof and with or without employment of an operating system. Software may be embodied on a computer readable medium such as a read/write hard disc, CDROM, Flash memory, ROM, etc. In order to execute a certain task, a software program may be loaded into or accessed by an appropriate processor as needed.

These and other aspects of the disclosure will be apparent in view of the attached figures and detailed description. The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific embodiments are described in detail to illustrate the inventive concepts to a person of ordinary skill in the art, such embodiments are susceptible to various modifications and alternative forms. Accordingly, the figures and written description are not intended to limit the scope of the inventive concepts in any manner.

### BRIEF DESCRIPTION OF THE DRAWINGS

Exemplary embodiments of the present disclosure will be understood and appreciated more fully from the following detailed description, taken in conjunction with the drawings in which:

FIG. 1A is a simplified block diagram illustrating various examples of elements or functions of an example of a cardboard-handling system suitable for various embodiments of the pre-treatmenter.

FIG. 1B is a simplified block diagram illustrating various exemplary elements of yet another exemplary embodiment of a cardboard-handling system.

FIG. 2A schematically illustrates a simplified example of a design of a pretreated cardboard.

FIG. 2B schematically illustrates a simplified example of a section of a cardboard item.

FIG. 3A schematically illustrates a simplified example of a design of a stripped pretreated cardboard.

FIG. 3B schematically illustrates a simplified example of a design of a stripped and blanked pretreated cardboard.

FIG. 4 depicts a schematic illustration of a simplified block diagram with relevant elements of an example of an embodiment of a vacuum sorter.

FIG. 5 depicts a schematic illustration of a simplified block diagram with relevant elements of an example of an embodiment of an under-laser vacuum sorter 500.

FIG. 6 schematically illustrates a simplified portion of a block diagram with relevant elements of an example of an embodiment of a peeler.

FIG. 8A schematically illustrates a simplified portion of a block diagram with relevant elements of an example embodiment of a selective drum, according to teaching of the present disclosure.

FIG. 8B schematically illustrates a simplified portion of a block diagram with relevant elements of an exemplary embodiment of a selective belt, according to teaching of the present disclosure.

FIG. 9A schematically illustrates a simplified portion of a block diagram with relevant elements of an exemplary embodiment of an electrically charged drum separator.

FIG. 9B schematically illustrates a simplified portion of a block diagram with relevant elements of an exemplary embodiment of an electrically charged belt separator.

FIG. 10 is a functional block diagram of the components of an exemplary embodiment of a system or sub-system operating as a controller or processor 1000 that could be used in various embodiments of the disclosure for controlling aspects of the various embodiments.

### DETAILED DESCRIPTION OF EXEMPLARY EMBODIMENTS

Turning now to the figures in which like numerals and/or labels represent like elements throughout the several views, exemplary embodiments, as well as features, aspects and functions that may be included in various embodiments of the present disclosure are described. For convenience, only some elements of the same group may be labeled with numerals. The purpose of the drawings is to describe exemplary embodiments and is not for production purpose. Therefore features shown in the figures are for illustration purposes only and are not necessarily drawn to-scale and were chosen only for convenience and clarity of presentation.

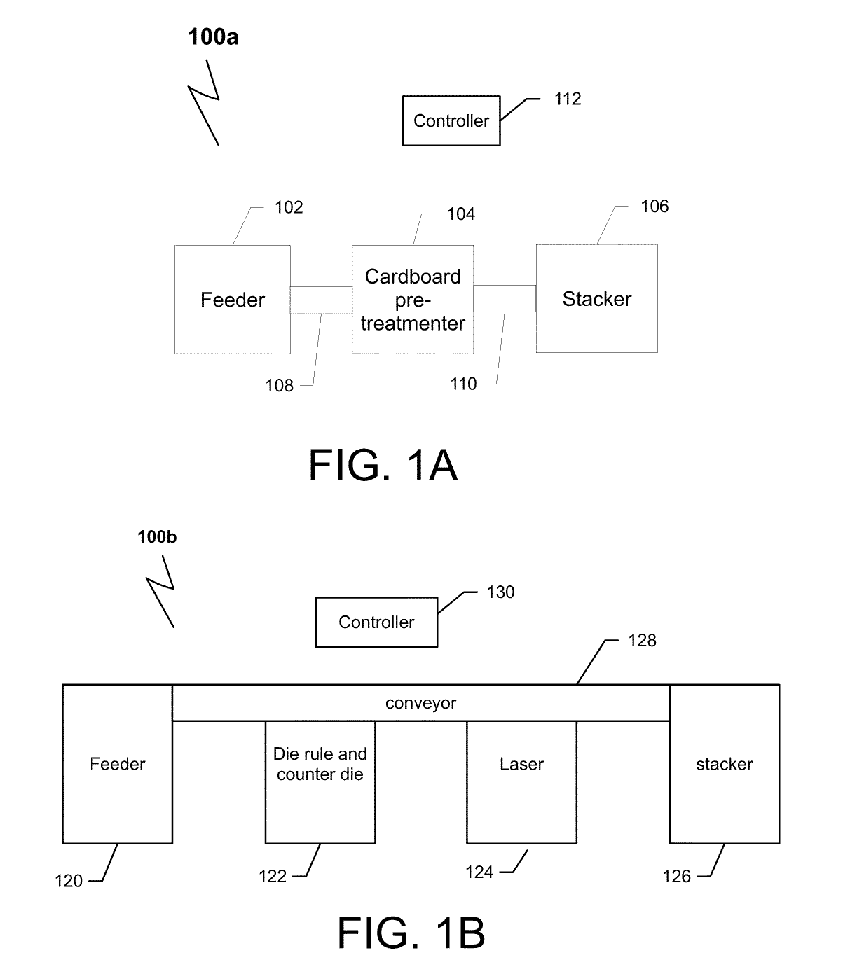

FIG. 1A is a simplified block diagram illustrating various examples of elements or functions of an example of a cardboard-handling system 100a suitable for various embodiments of the pre-treatmenter. The illustrated embodiment of the cardboard-handling system 100a is shown as including a feeder 102, a cardboard pre-treatmenter 104, a stacker 106, a controller 112, and one or more conveyors 108 and 110. It should be appreciated that the illustrated blocks in FIG. 1A, as well as other diagrams throughout the application, the blocks or elements may be provided to show categories of functionality that may or may not be included in various embodiments of the cardboard-handling system but are not necessarily separate functional systems or devices. Further, the functional separations illustrated are not for production but rather for illustration.

The feeder 102 may obtain, retrieve or receive a cardboard item and feed it toward a conveyor 108. The conveyor 108 may convey the cardboard item toward the cardboard pre-treatmenter 104. The cardboard pre-treatmenter 104 may pre-treat the cardboard. The pre-treatment of the cardboard may include one or more of a variety of operations, including, but not limited to, adding creases, cuttings, embossing of areas, piercing, apertures, indentations, scoring, printing, etc. After the pretreatment, a second conveyor 110 may convey the pre-treated cardboard toward the stacker 106.

The stacker 106 may stack the pre-treated cardboard items into a pile or stack. In some embodiments, the stacker 106 may incorporate the conveyor 110 or the conveyor may be integral to the stacker 106. The controller 112 may control and/or synchronize the operation of one or more of the cardboard-handling systems 100a modules. Other examples of cardboard-handling systems 100a may comprise other modules.

FIG. 1B is a simplified block diagram illustrating various exemplary elements of yet another exemplary embodiment of a cardboard-handling system 100b. The illustrated embodiment of the cardboard-handling system 100b is shown to include a feeder 120, a die-rule and counter-die 122, a laser 124, a stacker 126, a controller 130, and a conveyor 128.

In operation, initially the feeder 120 may get a cardboard item and feeds it toward a conveyor 128. The conveyor 128 may convey the cardboard item toward and/or through the die-rule and counter-die 122. The die-rule and counter-die 122 operates to pre-treat the cardboard item. The pre-treatment of the cardboard item can include one or more of a variety of operations, including, but not limited to, adding creases, cuttings, embossing of areas, piercing, apertures, indentations, scoring, printing, etc.

Next the conveyor 128 may convey the pre-treated cardboard item toward the laser 124 to be further pre-treated, for example, by the laser cutting the cardboard item. The conveyor 128 may then convey the pre-treated cardboard toward the stacker 126. The stacker 126 may stack the pre-treated cardboard items into a pile or stack. The controller 130 may synchronize and control one or more of the modules of the cardboard-handling system 100b.

The controller 130 may get input signals or data from different sensors along the cardboard-handling system 100, and accordingly, respond by sending commands to one or more modules. These commands may include, but are not limited to: setting the velocity of the conveyor, starting/stopping operation, grabbing/releasing cardboard, setting motion direction of the cardboard to forward or backward, as well as other commands and/or combination of two or more of any of these commands. In some embodiments, the controller may get information from an operator. Other examples of cardboard-handling systems 100a and 100b may comprise other modules, more of the same modules, only some of the described modules, etc. and as such, the configurations illustrated in FIG. 1A and FIG. 1B are non-limiting examples.

More information on embodiments of the cardboard-handling systems may be found in related U.S. patent applications bearing the title of “Cardboard-handling system and method” having U.S. Ser. No. 13/684,196 and PCT patent application bearing the title of “Cardboard-handling system and method” having serial number PCT/IL2012/000377, both of which are incorporated herein in the above Cross-reference to Related Applications section.

Other systems that may require a cardboard stacker may be, but are not limited to: coating systems (lamination coating, for instance); selective coating systems, printing systems, pre-print systems, post-print systems; finishing systems as well as combination of these and other systems.

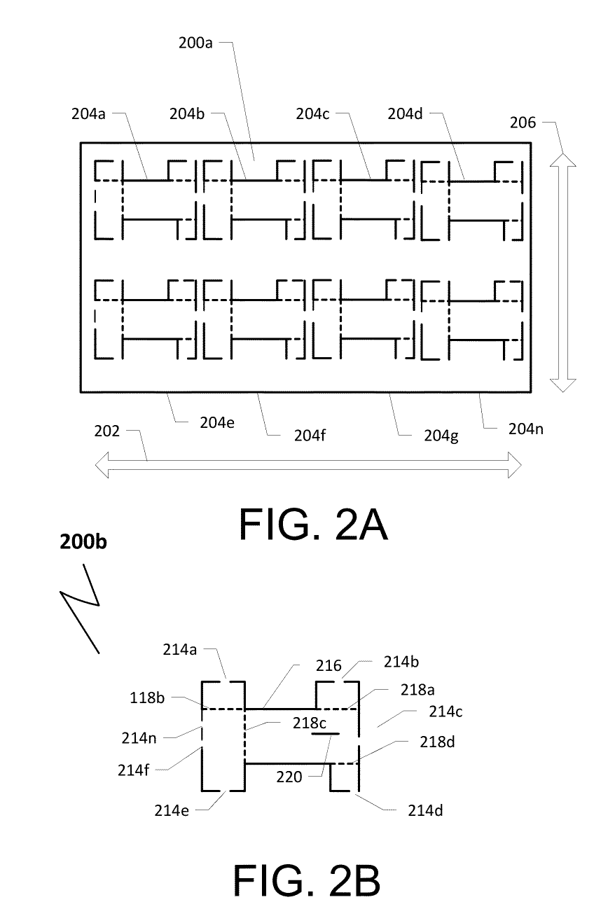

FIG. 2A schematically illustrates a simplified example of a design of a pretreated cardboard 200a. Pretreated cardboard 200a may comprise a plurality of sections 204a-n. Each section 204a-n may represent: a package layout; a printed image; a laminated area, a processed area; a combination of two or more of these as well as others. Henceforth, throughout the present description, drawings and claims, the word ‘section’ may be used as a representative word for the any of the above group of terms, as well as other structures.

Pre-treated cardboards 200a may vary in the parameters that are required for each job. For instance, in various non-limiting examples of pre-treated cardboards, the parameters may include one or more of, but are not limited to: width 206, length 202, number of sections 204a-n, type of material, thickness (not shown in drawing), etc. Furthermore, the sections 204a-n themselves may vary between the different jobs and between themselves.

FIG. 2B schematically illustrates a simplified example of a section of a cardboard item 200b. As a non-limiting example, a section 200b may be a package layout that includes a plurality of creases 218a-d. The creases 218a-d may ease the folding of the cardboard at the creased locations upon assembly or use of the packaging.

The package layout's 200b surrounding may be an un-continuous cut line 216 comprising a plurality of joints 214a-n (un-cut areas). The joints 214a-n may be used to keep the package layout 200b connected to a pre-treated cardboard from which it is created. Cuts may also be in the package layout, such as cut 220 for instance. The sections 204a-n thus may remain connected or partially connected to the pre-treated cardboard 200a by the joints 214a-n.

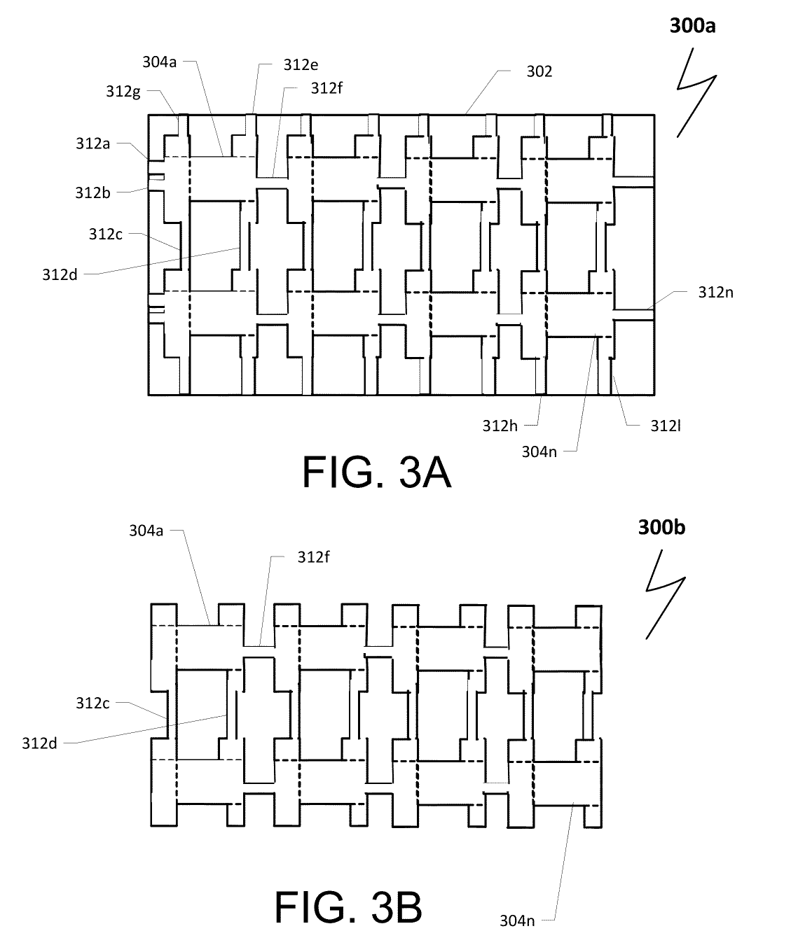

FIG. 3A schematically illustrates a simplified example of a design of a stripped pretreated cardboard 300a. A plurality of sections 304a-n are illustrated as being connected to one or more adjacent sections and connected to a surrounding border 302 by joints 312a-n. The stripped pretreated cardboard 300a can incorporate any of a variety of pretreated cardboards such as the pretreated cardboard 200a (FIG. 2A) stripped from the cardboard areas surrounding the sections and the joints. The stripping may be done by cutting the pretreated cardboard 200a along the borders of each section 304a-n and its joints 312a-n; and separating the connected sections and joints from the excess waste cardboard (not shown in drawing).

FIG. 3B schematically illustrates a simplified example of a design of a stripped and blanked pretreated cardboard 300b. A plurality of sections 304a-n are illustrated as being connected to one or more other sections by one or more joints 312a-n. The stripped and blanked pretreated cardboard 300b may be the pretreated cardboard 200a (FIG. 2A) stripped from the cardboard areas surrounding the sections and the joints, and stripped (blanked) from the surrounding boarder. The stripping and blanking may be done by cutting the pretreated cardboard 200a along the borders of each section 304a-n and its joints 312a-n; and separating the connected sections and joints from the excess waste cardboard (not shown in drawing) including the joints connecting the pre-treated cardboard's boarder to the sections.

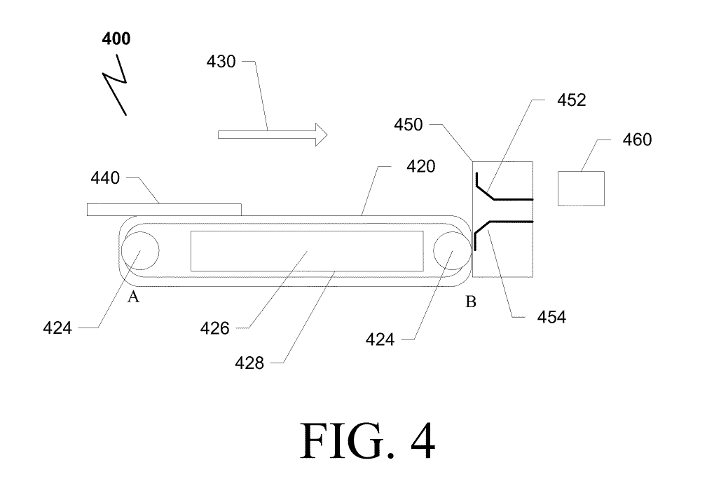

FIG. 4 depicts a schematic illustration of a simplified block diagram with relevant elements of an example of an embodiment of a vacuum sorter 400. The illustrated vacuum sorter 400 may be part of a cardboard-handling system. In other embodiments the vacuum sorter 400 may be an independent system that may or may not be incorporated or operated in conjunction with out systems.

The illustrated embodiment of the vacuum sorter 400 is shown as including: a vacuum chamber 426 that may generate vacuum and a belt 420 with a plurality of openings or apertures that fully penetrate through the belt 420 from the top surface and to the bottom surface (openings not shown in drawing). Two pulleys 424 at points A and B can move the belt 420.

The vacuum sorter 400 may be synchronized with one or more modules of the cardboard-handling system. In some exemplary embodiments, the synchronization may be realized by using a timing belt that is associated with or mechanically coupled to the belt 420 and to another module of the cardboard handling system, for instance. Thus, the belt 420 may start its movement and maintain a particular speed or velocity according to synchronizing inputs or controlling mechanisms, and so on.

Other synchronizing mechanism may be by applying one or more servo drivers and electronic synchronization. Two or more axis 422 may be used by the belt 420 as axis points to pivot around when moving in directions similar to arrow 430.

In some embodiments, the belt 420 may be constructed of a plurality of straps and the straps may include holes, apertures or other opening entirely extending through the straps. In other embodiments, the straps may be constructed without holes and rather, include gaps between two or more straps for the application of suction pressure underneath to secure the cardboard 440.

Some embodiments may further comprise a leader 450. A pretreated cardboard 440 may be obtained at point A and conveyed by the belt 420 toward the other end (point B). On the other edge (point B) the leader 450 may receive the pretreated cardboard 440.

An example of an embodiment of a leader 450 may comprise an upper arm with an angle 452 (15 degree, for instance) and a lower arm with an angle 454 (15 degree, for instance). When the pre-treated cardboard arrives to the edge (point B) it may hit one of the arms of the leader 450 and bounce toward the center of the leader 450, and/or bounce toward the other arm and then enter the leader 450. The angle of the arms may be configured according to different criteria and the illustrated embodiment is simply a non-limiting example. Non-limiting examples of the criteria that may affect the configuration of the leader 450 include: cardboard parameters, velocity of the cardboard, etc. Thus, in some embodiments the upper and lower arms may be constructed as illustrated, utilize a different angle, utilize an arching transition rather than an angle, use only an upper angle and ensure the lower arm is below the belt 420, or utilize only a lower angle and ensure that the upper arm is substantially above the belt, etc.

A peeler 460 may get the pre-treated cardboard from the leader 450. The peeler may incorporate a gripping mechanism or some other technique to secure the cardboard 440. The peeler 460 may grip an area of the pre-treated cardboard and encourage or bias it toward a collector (not shown in drawing) in the direction of arrow 430, for example. Advantageously, the area of the pre-treated cardboard gripped by the peeler 460 and the attached joints and their sections are peeled from the vacuum belt 420. The waste is left on the vacuum belt 420.

The waste may be removed from the vacuum belt 420 (such as a vacuum needle belt) by employing one or more different techniques. A non-limiting example of one such technique includes ensuring that the lower surface 428, or at least substantial portions thereof, of the vacuum chamber 426 may have no openings. Thus, when waste attached to the belt arrives to the lower surface 428 that does not include a fluid communication to the vacuum chamber 426, it may fall due to gravitation and no vacuum.

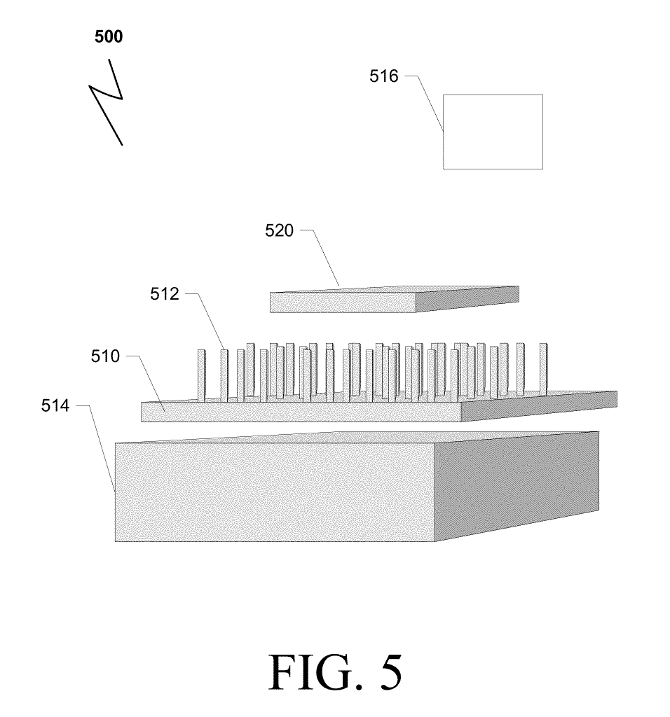

FIG. 5 depicts a schematic illustration of a simplified block diagram with relevant elements of an example of an embodiment of an under-laser vacuum sorter 500. The under-laser vacuum sorter 500 may stabilize a cardboard 520 in a fixed position while a laser 516 applies a pre-treatment to the cardboard 520. The under-laser vacuum sorter 500 may be similar to the vacuum sorter 400 of FIG. 4 and may further comprise: a plurality of protruding elements 512, positioned substantially parallel to each other.

The plurality of protruding elements 512 may be extend from a base 510. Exemplary protruding elements 512 may have a needle-like shape, for example. Exemplary base 510 may be a polymer-based material as a non-limiting example. In some exemplary embodiments, the material of the base 510 may be a glass fiber weaved to a textile. Other non-limiting examples of material that may be used for the base 510 include Nano structured surfaces and carbon fiber material.

The cardboard 520 may be placed in a substantially horizontal position on the top of the protruding elements 512. A coupling and stabling mechanism may be used to couple and stabilize the cardboard to the top of the protruding elements 512. An example of a coupling and stabling mechanism may comprise a plurality of openings in the base 510 (not shown in drawing) and a suction mechanism may be used. Suction mechanism such as, but not limited to a vacuum generator 514, for example. The suction mechanism may couple and stabilize the cardboard to the top of the protruding elements 512.

In some embodiments the base may be constructed of or configured as a plurality of straps. The straps may include holes that fully penetrate through the belt. In other embodiments, the straps may not include holes, but rather include gaps between two or more straps for the suction underneath to be applied to the surface of the cardboard 520.

The base 510 of the under-laser vacuum sorter 500 may be a conveying belt, as a non-limiting example. The base 510 can travel conveying the cardboard 520 under the laser 516.

Synchronization may be implemented between the under-laser vacuum sorter 510 and one or more modules of the cardboard-handling system, for example.

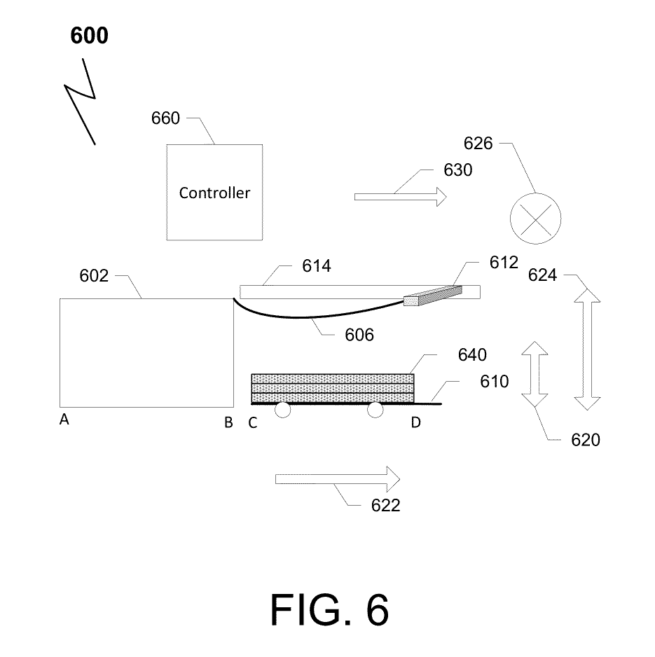

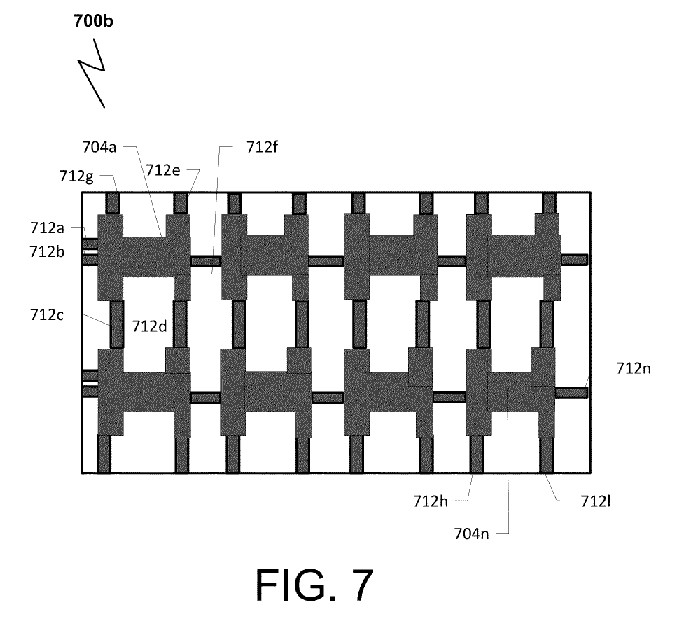

FIG. 6 schematically illustrates a simplified portion of a block diagram with relevant elements of an example of an embodiment of a peeler 600. The peeler 600 may transfer or assist in the transfer of jointed sections and/or sections, for example, to a pile 640 in a collector 610.

An example of embodiment of a peeler 600 may include a gripping mechanism 612. The gripping mechanism 612 may get an area of a pre-treated cardboard, such as the leading edge of a pre-treated cardboard 606 for instance. The various sections of the pre-treated cardboard 606 are attached to the leading edge of the pre-treated cardboard by one or more joints. The gripping mechanism 612 may grip the leading edge of the pre-treated cardboard 606 from substantially the edge of a vacuum sorter 602, and lead or guide the pre-treated cardboard 606 toward a pile 640 that may accumulate in collector 610—the movement being in the direction of arrow 630. Advantageously, the waste can be maintained on the vacuum sorter belt rather than accumulating in the collector 610.

The gripping mechanism 612 may be associated with a bar, trail or track or other conveyance mechanism 614. The association may be by wheels on a track, a belt, rotating chain mechanism, linear guide motor, rails, rollers, etc. The gripping mechanism 612 may move along the conveyance mechanism 614 in a direction similar to arrow 630 and/or reversal. The height 624 of the gripping mechanism 612 and the conveyance support 614 may be adapted according to different criteria, such as, but not limited to: job description, height of the pile 620, vacuum sorter 602 height, the job layout, etc.

In some embodiments, the conveyance mechanism 614 and/or gripping mechanism 612 may move in direction similar or opposite to arrow 626 (perpendicular to arrow 630). In other embodiments a combination of the different directions may be embodied. The gripping mechanism 612 may comprise a plurality of automatic-adjustable grippers. Examples of grippers may include, but are not limited to: clamps, grippers, vacuum, as well as other techniques and a combination of two or more such techniques. In some embodiments, the plurality of automatic-adjustable grippers 612 may be individual sub-units, and/or an array of automatic-adjustable grippers 612 connected to a single rod, and so on.

Some embodiments may further comprise a controller 660. The controller 660 may synchronize between the different modules of the vacuum sorter 602 and the peeler 600. An exemplary controller 660 may obtain input from: an operator; sensors; one or more modules of a cardboard-handling system of which the vacuum sorter 602 is part of; etc.

The synchronization may be: between the arrival of a pre-treated cardboard 606 and the gripping mechanism 612; and/or the placement and/or height of the gripping mechanism 612 according to the length, width, placement and/or velocity of the pre-treated cardboard 606; as well as other parameters. The controller 660 may command or control one or more actuators of the peeler modules and/or other one or more other modules of the cardboard-handling system that the cardboard pre-treatmenter is part of.

As previously noted in connection with FIG. 3A, the pre-treated cardboard includes sections 304a-n treated by dies and/or laser. Each section 304a-n may be held to the surrounding cardboard and/or to one or more other sections 304a-n by joints 312a-n.

The novel system and method to separate the required sections from the pre-treated cardboard may further comprise creating a separating mask. FIG. 7 is a schematic diagram that illustrates an exemplary separating mask 700. Exemplary separating mask 700 may have a substantially similar shape as a pretreated cardboard layout of the sections 304a-n and their joints 312a-n. In other exemplary embodiments, the separating mask 700 may have a substantially negative image of the shape of the layout of the sections 704a-n and their joints.

The separating mask 700 material may be cardboard, plastic, PET, etc. The separating mask 700 may be produced by the cardboard-handling system itself (dies and/or laser.), such as the cardboard-handling system similar to the ones depicted in FIG. 1a-b, for example.

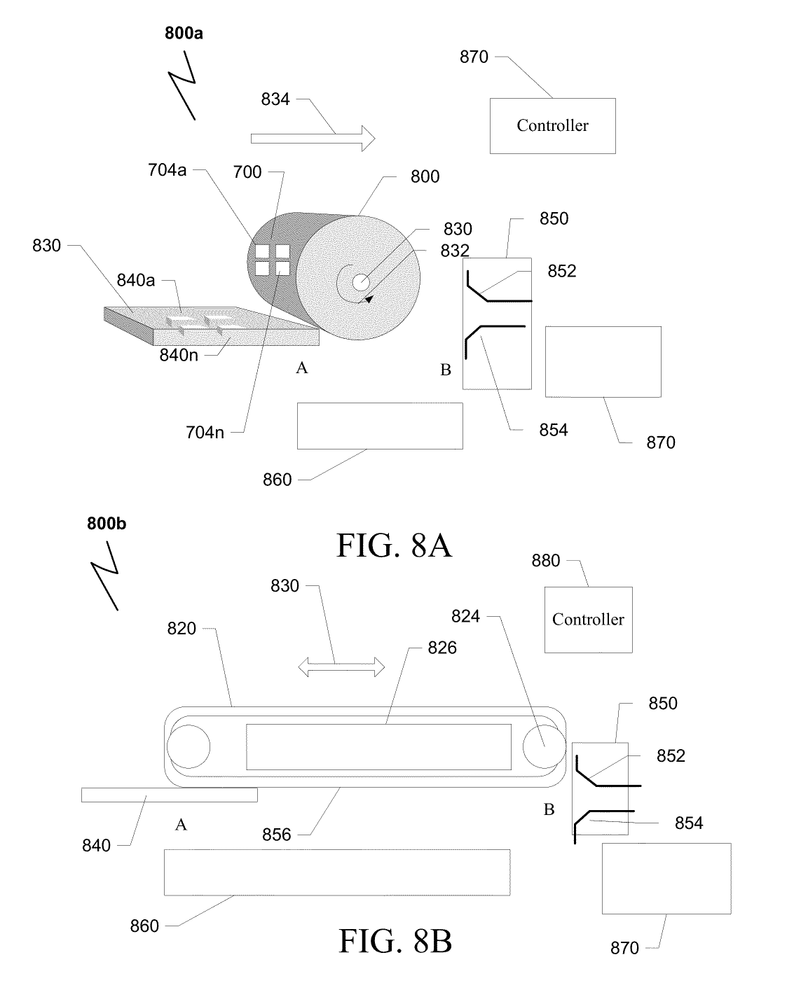

The separating mask 700 may be placed on the surface of a selective drum similar to the selective drum described in FIG. 8A following.

FIG. 8A schematically illustrates a simplified portion of a block diagram with relevant elements of an example embodiment of a selective drum 800, according to teaching of the present disclosure. Selective drum 800 may be part of a cardboard-handling system 800a, for example. In other embodiments it may be a standalone unit. An exemplary embodiment of a selective drum 800 may comprise a vacuum chamber existing within or applying the vacuum force within the interior of the selective drum 800. The surface of the selective drum 800 may comprise a plurality of openings that extend to the interior of the selective drum 800 (not shown in drawing). The selective drum 800 may pivot in the direction of arrow 832 around a center axis 830, for example.

A pretreated cardboard 830 may be moved to a position adjacent to the selective drum 800 (point A) by a conveyor or other mechanism. The pretreated cardboard 830 may have one or more sections 840a-n. A separating mask 700 may be associated with the surface of the selective drum 800. The association may be by grippers, vacuum, etc. The layout of the separating mask 700 may be a negative image to the sections 840a-n of the pretreated cardboard 830 and include areas 704a-n that corresponds with sections 840a-n. In other embodiments, the layout of the separating mask 700 may be a similar to the sections 840a-n of the pretreated cardboard 830.

The pretreated cardboard 830 may be pulled or encouraged or biased by the selective drum 800 from point A to point B. The cooperation of the vacuum and movement of the drum may create the movement of the cardboard 830, for example. In another exemplary embodiment, the movement may be realized by the use of a gripper (not shown in drawing), and so on. At point B a leader 850 may be implemented.

An example of a leader 850 may comprise an upper arm with an angle 852 (15 degree, for example) and a lower arm with an angle 854 (15 degree, for example). When a pre-treated cardboard hits one of the arms it may bounce toward the center of the leader 850, and/or bounce toward the other arm and then enter the leader 850, and so on. The angle of the arms may be according to different criteria. Exemplary criteria may be: cardboard parameters, velocity of the cardboard, etc. The other variations of the leader mentioned above with reference to FIG. 4 also apply here.

At the end of the leader 850, a pile 870 of separated pre-treated cardboard may be accumulated. In some embodiments, the leader 850 may move toward the drum in order to pull the pre-treated cardboard. The waste left on the surface of the drum may be removed by a brush (not shown in drawing) at a low point of the drum toward pile 860, and/or at the low point of the drum there may be an area with no vacuum, etc.

In embodiments that the separating mask 700 is a negative image of sections together with their joints, the sections together with their joints may cling to the selective drum 800 toward point B. The remaining parts of the pre-treated cardboard may be masked from the vacuum by the separating mask 700 and thus fall by gravitational force toward a basket 860, for example. At point B the leader may scrape and lead the sections together with their joints toward a pile of other sections together with their joints, and/or toward another module. Other modules may operate in conjunction with the illustrated embodiment, such as, but not limited to: a conveyor, a stacker, etc.

Some exemplary embodiments may further comprise a controller 870. The controller may synchronize between the selective drum 800 and different modules. Exemplary different modules may be modules of a cardboard-handling system, a stacker, a conveyor, etc. An exemplary controller 870 may receive indications from mechanical sensors, electro/optical sensors, and/or electro/mechanical sensors, and/or a user. Exemplary sensors may indicate the placement of the pretreated cardboard before it reaches point A. Accordingly, the controller can command the selective drum 800 to pivot in a way that the separating mask 700 on its surface will match the incoming pretreated cardboard, for example.

The controller may further synchronize between the arrival of output of the selective drum 800 and a gripping mechanism of a stacker, and so on. The controller may send commands toward the one or more actuators incorporated into the one or more modules of the cardboard handling system and/or the selective drum 800.

In other exemplary embodiments, where the separating mask 700 is similar to the sections together with their joints, then basket 860 may collect the sections together with their joints, and pile 870 may accumulate the remaining areas of the pretreated cardboard.

In some embodiments, there may be a requirement to further separate the section) form each other themselves.

FIG. 8B schematically illustrates a simplified portion of a block diagram with relevant elements of an exemplary embodiment of a selective belt 800b, according to teaching of the present disclosure. The illustrated embodiment of the exemplary selective belt 800b may be part of a cardboard-handling system, for example. The selective belt 800b may convey a pre-treated cardboard 840 on the bottom surface of the selective belt 800b, for example.

An exemplary embodiment of a selective belt 800b may comprise: a vacuum chamber 826 that may generate a vacuum. An exemplary embodiment of a vacuum chamber may further comprise: a vacuum belt 820 with a plurality of openings penetrating through the belt (openings not shown in drawing) for example. A separating mask may be associated with the surface of the vacuum belt 820 (not shown in drawing). The association may be by grippers, vacuum, etc. The separating mask layout may be a negative image to the sections of the pretreated cardboard 840. In other embodiments the separating mask layout may be a similar to the sections of the pretreated cardboard 840.

The pretreated cardboard 840 may be encouraged, biased or otherwise pulled by the vacuum belt 820 from point A toward point B. The pulling may be by the cooperation of the vacuum and movement of the belt, for example. In another exemplary embodiment, the pulling may be by a gripper(s) (not shown in drawing), and so on. At point B, a leader 850 may be implemented. An exemplary embodiment of a leader may be similar to the one described in FIG. 8A. At the end of the leader 850, a pile of separated pre-treated cardboard may be accumulated.

Thus the pretreated cardboard 840 may be transmitted by the vacuum belt 820 from point A toward point B. In embodiments that the separating mask is a negative image of sections together with their joints, the sections together with their joints may cling to the vacuum belt 820 toward point B. The remaining parts of the pre-treated cardboard may be masked from the vacuum by the separating mask and thus fall by gravitation toward a basket 860, for example.

At point B, the leader may scrape and lead the sections together with their joints toward a pile of other sections together with their joints, and/or toward another module, such as, but not limited to: a conveyor, a stacker, etc.

The selective belt 800b may be synchronized with one or more modules of a cardboard-handling system. One exemplary embodiment of synchronization may be by a timing belt associated to the vacuum belt 820 and to a side gripper, for example. Thus the vacuum belt 820 may start its movement and velocity according to synchronizing inputs, and so on. Other exemplary synchronizing mechanism may be by applying one or more servo drivers and electronic synchronization. Two or more axis 822 may be used by the vacuum belt 820 as axis points to pivot around when moving in directions similar to arrow 830, for example.

Some exemplary embodiments the vacuum belt 820 may be made of a plurality of straps. The straps may be with wholes. In other embodiments the straps may be without wholes but with gaps between two or more straps for the suction underneath to affect the cardboard.

Some exemplary embodiments may further comprise a controller 880. The controller 880 may synchronize between the selective belt 800b and different modules. Examples of such different modules may be modules of a cardboard-handling system, a stacker, a conveyor, etc. An exemplary controller 880 may receive indications from mechanical sensors, electro/optical sensors, and/or electro/mechanical sensors, and/or a user. Exemplary sensors may be indicate the placement of the pretreated cardboard before it reaches point A. Accordingly, the controller can command the selective belt 800b to pivot in a way that the separating mask on its surface will match the incoming pretreated cardboard, for example.

The controller 880 may further synchronize between the arrival of output of the selective belt 800b and a gripping mechanism of a stacker, and so on. The controller 880 may send commands toward the one or more actuators at one or more modules of the cardboard handling system and/or the selective belt 800b.

In other exemplary embodiments, where the separating mask is similar to the sections together with their joints, then basket 860 may accumulate the layout of the package together with their joints, and pile 870 may accumulate the remaining areas of the pretreated cardboard.

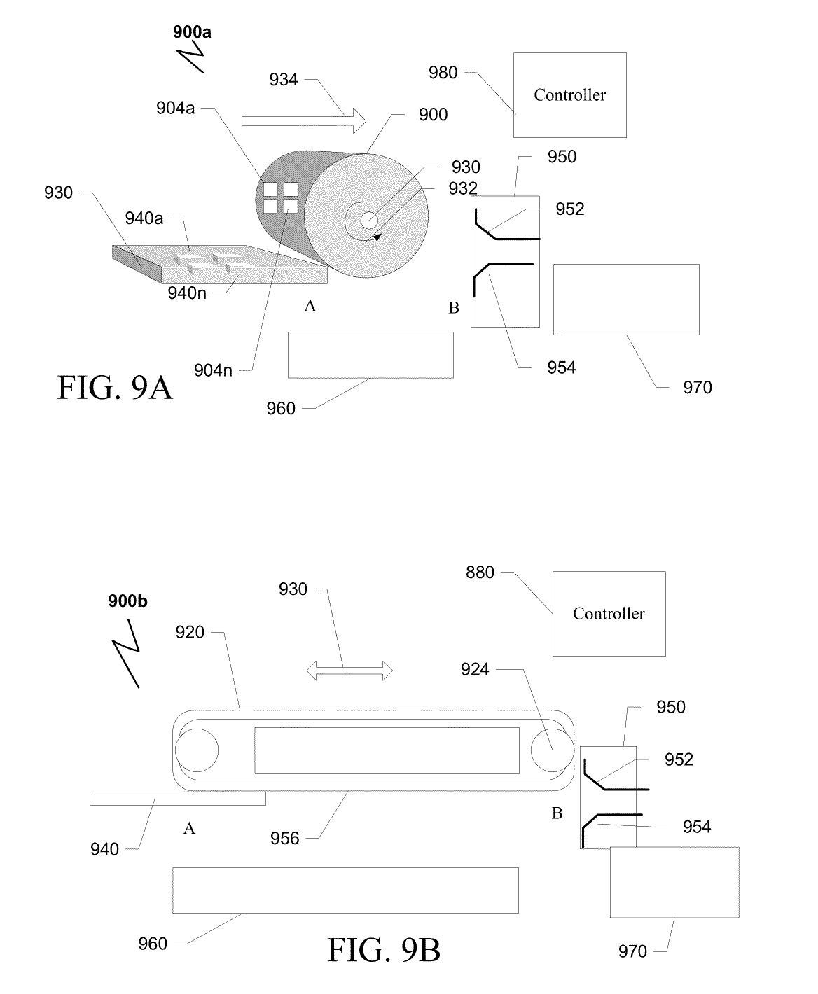

FIG. 9A schematically illustrates a simplified portion of a block diagram with relevant elements of an exemplary embodiment of an electrically charged drum separator 900a. The illustrated electrically charged drum separator 900a may be electrically charged. The electric charged drum separator 900a may then be uncharged at predefined areas by a laser beam, for example. The predefined areas to be uncharged may be similar to the layout of the package together with their joints. In other embodiments, the predefined areas may be a negative image of the layout of the package together with their joints. The work of a system comprising an electrically charged drum separator 900a may be similar to the description of FIG. 8A detailed above.

FIG. 9B schematically illustrates a simplified portion of a block diagram with relevant elements of an exemplary embodiment of an electrically charged belt separator 900b. An exemplary embodiment of an electrically charged belt separator 900b, may be charged with an electric charge. The electric charged belt separator 900b may then be uncharged at predefined areas by a laser beam, for example. Predefined areas may be similar to the layout of the package together with their joints. In other embodiments, the predefined areas may a negative image of the layout of the package together with their joints. The work of a system comprising an electrically charged belt separator 900b may be similar to the description of FIG. 8B detailed above.

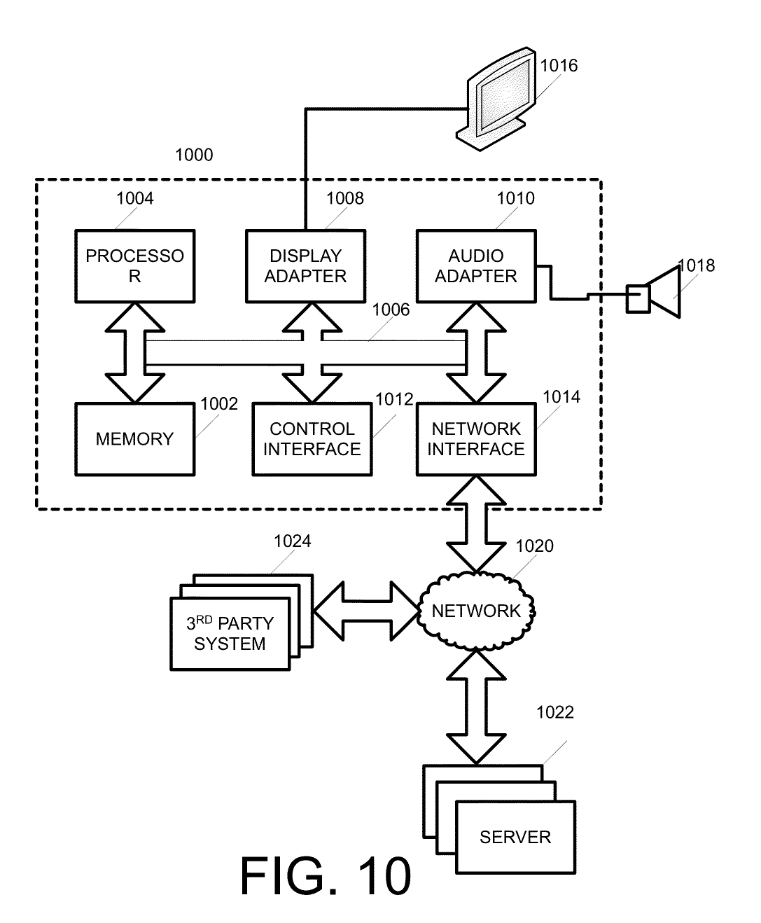

FIG. 10 is a functional block diagram of the components of an exemplary embodiment of a system or sub-system operating as a controller or processor 1000 that could be used in various embodiments of the disclosure for controlling aspects of the various embodiments. It will be appreciated that not all of the components illustrated in FIG. 10 are required in all embodiments of the activity monitor but each of the components are presented and described in conjunction with FIG. 10 to provide a complete and overall understanding of the components. The controller can include a general computing platform 1000 illustrated as including a processor 1002 and memory device 1004 that may be integrated with each other or communicatively connected over a bus or similar interface 1006. The processor 1002 can be a variety of processor types including microprocessors, micro-controllers, programmable arrays, custom IC's etc. and may also include single or multiple processors with or without accelerators or the like. The memory element of 1004 may include a variety of structures, including but not limited to RAM, ROM, magnetic media, optical media, bubble memory, FLASH memory, EPROM, EEPROM, etc.

The processor 1002, or other components in the controller may also provide components such as a real-time clock, analog to digital convertors, digital to analog convertors, etc. The processor 1002 also interfaces to a variety of elements including a control interface 1012, a display adapter 1008, an audio adapter 1010, and network/device interface 1014. The control interface 1012 provides an interface to external controls such as but not limited to: sensors, actuators, drawing heads, multiple-orifice nozzles, cartridges, pressure actuators, leading mechanism, drums, step motors, a keyboard, a mouse, a pin pad, an audio activated device, as well as a variety of the many other available input and output devices or, another computer or processing device or the like.

A display adapter 1008 can be used to drive a variety of alert elements 1016, such as, but not limited to: display devices including an LED display, LCD display, one or more LEDs or other display devices. An audio adapter 1010 may interface to and drive another alert element 1018, such as a speaker or speaker system, buzzer, bell, etc.

A network interface 1014 may interface to a network 1020, which may be any type of network including, but not limited to the Internet, a global network, a wide area network, a local area network, a wired network, a wireless network or any other network type including hybrids. Through the network 1020, or even directly, the controller 1000 can interface to other devices or computing platforms such as but not limited to: one or more servers 1022 and/or third party systems 1024. A battery or power source may provide power for the controller 1000.

Unless otherwise defined, all technical and/or scientific terms used herein have the same meaning as commonly understood by one of ordinary skill in the art to which the disclosure pertains. In case there is a conflict in the definition or meaning of a term, it is intended that the definitions presented within this specification are to be controlling. In addition, the materials, methods, and examples that are presented throughout the description are illustrative only and are not necessarily intended to be limiting.

Reference in the specification to “one embodiment” or to “an embodiment” means that a particular feature, structure, or characteristic described in connection with the embodiment is included in at least one embodiment of the disclosure, and multiple references to “one embodiment” or “an embodiment” should not be understood as necessarily referring to the same embodiment or all embodiments.

Implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof and with or without employment of an operating system. Software may be embodied on a computer readable medium such as a read/write hard disc, CDROM, Flash memory, ROM, etc. In order to execute a certain task, a software program may be loaded into or accessed by an appropriate processor as needed.

The foregoing description is not intended to summarize each potential embodiment or every aspect of the present disclosure, and other features and advantages of the present disclosure will become apparent upon reading the following detailed description of the embodiments with the accompanying drawings and appended claims.

Furthermore, although specific embodiments are described in detail to illustrate the inventive concepts to a person of ordinary skill in the art, such embodiments are susceptible to various modifications and alternative forms. Accordingly, the figures and written description are not intended to limit the scope of the inventive concepts in any manner.

In the description and claims of the present disclosure, each of the verbs, “comprise”, “include” and “have”, and conjugates thereof, are used to indicate that the object or objects of the verb are not necessarily a complete listing of members, components, elements, or parts of the subject or subjects of the verb and further, all of the listed objects are not necessarily required in all embodiments.

As used herein, the singular form “a”, “an” and “the” include plural references unless the context clearly dictates otherwise. For example, the term “a material” or “at least one material” may include a plurality of materials, including mixtures thereof.

In this disclosure the words “unit”, “element”, and/or “module” are used interchangeably. Anything designated as a unit, element, and/or module may be a stand-alone unit or a specialized module. A unit, element, and/or module may be modular or have modular aspects allowing it to be easily removed and replaced with another similar unit, element, and/or module. Each unit, element, and/or module may be any one of, or any combination of, software, hardware, and/or firmware. Software of a logical module can be embodied on a computer readable medium such as a read/write hard disc, CDROM, Flash memory, ROM, etc. In order to execute a certain task a software program can be loaded to an appropriate processor as needed.

The present disclosure has been described using detailed descriptions of embodiments thereof that are provided by way of example and are not intended to limit the scope of the disclosure. The described embodiments comprise different features, not all of which are required in all embodiments of the disclosure. Some embodiments of the present disclosure utilize only some of the features or possible combinations of the features. Many other ramifications and variations are possible within the teaching of the embodiments comprising different combinations of features noted in the described embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

It will be appreciated by persons skilled in the art that the present disclosure is not limited by what has been particularly shown and described herein above. Rather the scope of the disclosure is defined by the claims that follow.

We claim:

1. A vacuum sorter comprising:
a controller
a vacuum chamber having openings along a portion of its surface; and
a peeler;
wherein a pre-treated cardboard is placed along the surface of the vacuum chamber and the controller is configured to cause the peeler to couple to an area of the pre-treated cardboard and apply a force to bias a portion of the pre-treated cardboard away from the vacuum chamber surface.

2. The vacuum sorter of claim 1, wherein the vacuum sorter operates in conjunction with a laser that cuts required areas along the pretreated cardboard.

3. The vacuum sorter of claim 1, wherein the vacuum chamber fluidly communicates with a plurality of openings that are defined by a belt that is associated with the surface of the vacuum chamber.

4. The vacuum sorter of claim 1, further comprising a plurality of belts that are placed onto the surface of the vacuum chamber with gaps between them.

5. The vacuum sorter of claim 1, wherein the vacuum sorter operates in conjunction with a cardboard handling system.

6. The vacuum sorter of claim 5, wherein the vacuum sorter operates in conjunction with a SART cardboard handling system.

7. The vacuum sorter of claim 1, wherein the peeler comprises a gripping mechanism.

8. The vacuum sorter of claim 1, wherein peeler comprises a leader.

9. The vacuum sorter of claim 1, further comprising a brush that is configured to rub the surface of the vacuum chamber.

10. The vacuum sorter of claim 1, vacuum chamber surface is a conveyor.

11. The vacuum sorter of claim 1, wherein the vacuum chamber surface has at least one area in which no openings exist.

12. A selective mask sorter, comprising:
a controller;
a vacuum chamber;
a conveyor with at least one opening along a portion of its surface, the opening being in fluid communication with an interior of the vacuum chamber;
wherein a selective mask is placed onto the surface of the conveyor, the selective mask having openings of substantially the same size, shape and location as corresponding areas existing on a pre-treated cardboard that will be conveyed by the conveyor and that is required to cling to the conveyor; and
wherein the controller synchronizes between the arrival of the pre-treated cardboard and the conveyor motion.

13. The selective mask sorter of claim 13, further comprising a leader that strips a portion of the pre-treated cardboard from the conveyor.

14. The selective mask sorter of claim 13, wherein the conveyor is a belt.

15. The selective mask sorter of claim 13, wherein the material of the selective mask comprises polymer.

16. The selective mask sorter of claim 13, wherein the material of the selective mask comprises a cardboard.

17. The selective mask sorter of claim 13, wherein the layout of cuts in the selective mask is a negative of at least the sections of the pretreated cardboard.

18. A selective mask sorter, comprising:
a controller;
a conveyor with a coating that holds an electrical charge along a portion of its surface; and
a discharger;
wherein the discharger discharges the conveyor surface at areas substantially similar in size, shape and location as areas of a pre-treated cardboard that are required to cling to the conveyor when been conveyed by the conveyor; and wherein the controller synchronizes between the arrival of the pre-treated cardboard and the conveyor motion.

19. The selective mask sorter of claim 18, further comprising a leader that strips a portion of the pre-treated cardboard from the conveyor.

20. The selective mask sorter of claim 18, wherein the conveyor is a belt.

21. The selective mask sorter of claim 18, wherein the selective mask layout of cuts is a negative of at least the section of the pretreated cardboard.
